(19) United States
(12) Patent Application Publication
(10) Pub. No.: US 2005/0261869 A1
(43) Pub. Date: Nov. 24, 2005

(54) Arrangement and method for producing therapeutic insoles

(76) Inventors: Roland Leyerer, Neubeuern (DE); Doug Haas, Havertown, PA (US); Francis Rementilla, Toronto (CA)

Correspondence Address: ANDREW F. YOUNG, P.C., 115 ORCHID STREET, FLORAL PARK, NY, 11001, US

(21) Appl. No.: 10/719,646

(22) Filed: Nov. 21, 2003

(30) Foreign Application Priority Data
Oct. 9, 2003 (DE) DE 103 46 952.4

(51) Int. Cl. G06F 15/00

(52) U.S. Cl. 702/150

(57) ABSTRACT

Arrangement for producing therapeutic insoles, consisting of a platform with a scanner for scanning the undersides of the patient's feet, a data processing connection for transmitting the scanned image to a computer, a data processing computer program which converts the transmitted data into working instructions for the control of a milling machine, and of said milling machine which mills a therapeutic insole from a blank according to said working instructions, whereby neurological proceptors are placed on the scanner under the patient's foot in accordance with the patient's predisposition, whereby the proceptors are part of a set of standardized proceptors having various dimensions, whereby the proceptors are identified by markings on their underside, and whereby the scanned image contains the identifying markings and the orientation of the proceptors.

The present invention relates to an arrangement and a method for producing therapeutic insoles with the characteristics of the generic part of claim 1.

It is known in prior art to produce orthopedic insoles with the aid of a computer. Thus, EP 0 284 922 A2 suggests that the patient stands on a foot imprint unit consisting of pressure-sensitive measuring elements transmitting pressure to a sensor unit which converts them into digital signals to be processed by a computer. The computer can also have stored additional information, and a shoe insole calculated from both sources can compensate for any existing defect. The data are converted into manufacturing data for a profiling tool. EP 0 317 591 B1 discloses a measuring arrangement for dynamic measuring where the patient walks across the measuring arrangement. In that case, too, the pressure force distribution pattern is digitized and compared by computer with a set value. Control signals for an arrangement for producing insoles are derived from the result. DE 94 00 979 U shows an assembly for the production of therapeutic insoles which X-rays the foot under stress and at rest and then scans the foot with hydraulic or pneumatic sensor elements. The resulting data are also converted into manufacturing data for insoles. Finally, DE 44 04 695 C2 discloses a method for acquiring geometric data of a foot by means of measuring soles, a blue-print or a manually produced orthopedic insole. The data are given to a data processor in which a number of measurements of prefabricated blanks is stored. From the data sets, the operator can determine the desired form of the insole and decide which blank is to be used. The data are then converted further into manufacturing signals for a milling machine.

All the above named arrangements and methods proceed from measuring the nature of the foot to produce the appropriate insoles which are made to react passively to certain foot disorders such as flatfoot, splayfoot, clubfoot, pes valgus, pes adductus congenitus, etc.

However, feet are also the subject of other forms of therapy such as acupressure, reflexology, neurological stimulation, etc. Insoles have also been suggested already for those purposes. They were formed such that certain receptors under the feet were stimulated to treat problems of body balance. In contrast to the above mentioned orthopedic insoles, such hand-made or cast insoles have an active, stimulating effect. A special form is the stimulation of the so-called proprioceptors, i.e. the free nerve endings of the muscles whose impulses together with those of the labyrinth (the organ governing balance) provide the brain with the necessary information about body posture.

It is therefore the object of the present invention to create an arrangement and a method for facilitating an automated process from a determination of the suitable form and positioning of stimulators for the proprioceptors in the sole of the foot to the manufacture of insoles derived from these.

This object is achieved with the characteristics of the generic part of claim 1. Further developments and advantageous embodiments are described in the sub-claims.

The invention relates to an arrangement for producing therapeutic insoles consisting of a platform with a scanner for scanning the undersides of a patient's foot, a data transmission for transmitting the scanned image to a computer, a data processing program which converts the transmitted data to working instructions for controlling a milling machine, and said milling machine which in accordance with the working instructions mills a therapeutic insole from a blank, characterized in that neurological proceptors are arranged in accordance with the patient's predisposition on the scanner under the patient's foot which assumes a predetermined orientation, that the proceptors belong to a set of standardized proceptors of various sizes, that the proceptors are marked, for example on their underside, and that the scanned image contains the markings and the orientation of the proceptors. In this context, proceptors are geometrically defined stimulators which act upon the proprioceptors in the sole of the foot. The marking of the proceptors can take the form of shape and/or size or of imprints, coloration, stickers, embossings, etc.

Thus, the markings and the orientation of the proceptors represent the information the computer needs for the conversion into working instructions for controlling the milling machine.

The invention also relates to a method for producing a therapeutic insole consisting of the following steps:
5. Method of producing a therapeutic insole, consisting of the following steps:
   Preparing a platform with a scanner for the underside of the patient's foot;
   Aligning the patient's foot position in accordance with a predetermined orientation;
   Arranging proceptors marked on the underside under the patient's foot according to a predisposition of the patient;
   Scanning the underside of the patient's foot with the proceptors arranged under it;
   Transmitting the scanned image to a computer;
   Converting the information of the image by the computer into working instructions for controlling a milling machine, whereby the computer is programmed with computing steps representing the respective markings and the orientation of the proceptors;
   Milling the therapeutic insoles from prefabricated blanks in accordance with the working instructions;
   whereby the working instructions are substantially based on the processing of the markings and the orientation of the proceptors and whereby not only the contours of the therapeutic insole, but also the dimensions of the proceptors are milled out.

There is an automatic sequence between the scanning and milling steps. It is not necessary for the operators to intervene in data processing.

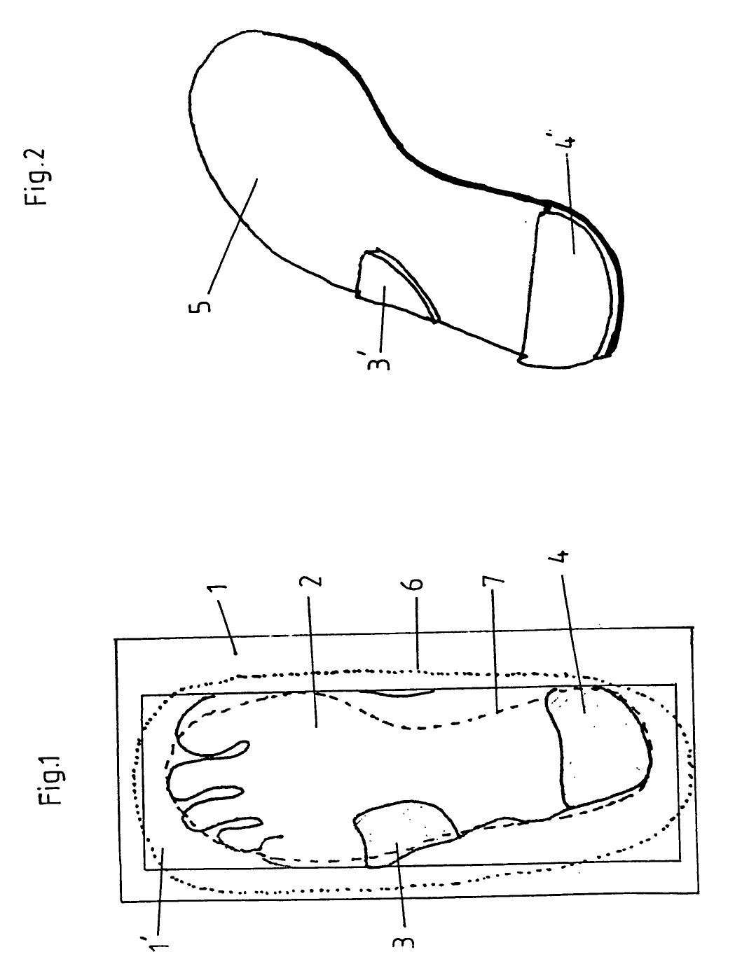

Below, the invention is described in detail by means of practical examples, with reference to the drawings, where
FIG. 1 is a schematic view of a scanned image;

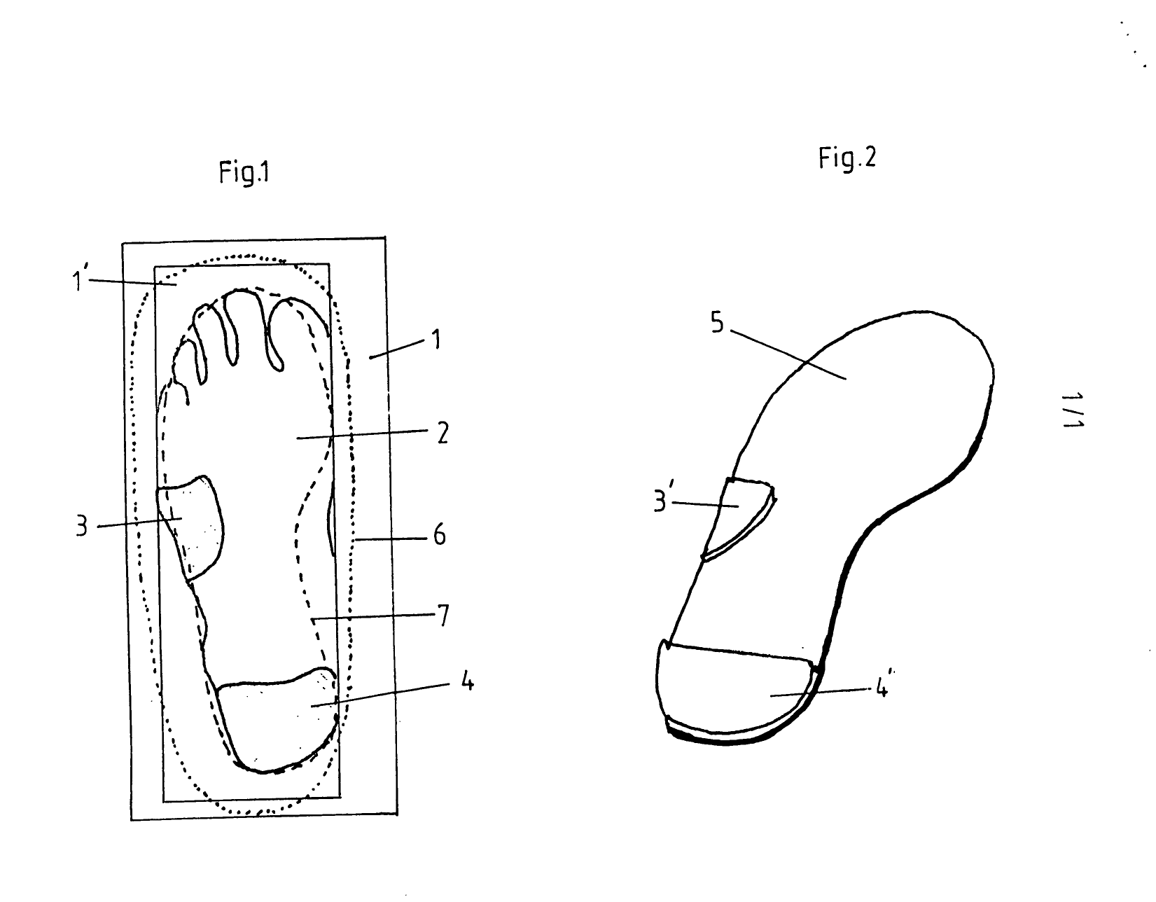

FIG. 2 is a schematic view of the configuration of proceptors on a therapeutic insole.

The scanned image of FIG. 1 shows a foot 2 resting on a transparent plate 1′ of a 2-D scanner 1. The contour lines 6 and 7 represent a coarser and a closer auxiliary line for covering the current position of the foot and its proportions. Two proceptors 3, 4 are placed under the foot 2. The proceptors consist of a rigid material such as cork or a strong plastic. The proceptors are configured by skilled personnel according to certain predispositions of the patient's body posture. Then, the foot with the proceptors is scanned, and the image containing information about the proportions of the foot and the type and orientation of the proceptors is converted into data that can be processed by a computer (not shown). The computer turns these data into working instructions for a milling machine (not shown) which follows these instructions to cut the insole 5 (as in FIG. 2) from a blank. No technician has to intervene in the step in which the data of the scanned image are evaluated and converted into working instructions for the milling machine; no corrections are necessary, and no blanks have to be adapted. The view in FIG. 2 shows only the proceptors 3′ and 4′, which have been cut out by the milling machine. Of course, the finished insole can include other contours such as a foot bed. Preferably, the insole consists of an industrial plastic foam such as E/VA that is covered with a microfiber material.

1. Arrangement for producing therapeutic insoles, comprising:
a platform with a scanner for scanning an underside of a patient's feet;
a data processing connection for transmitting the scanned image to a computer;
a data processing computer program which coverts the transmitted data into working instructions for the control of a milling machine;
said milling machine enabling a milling of a therapeutic insole from a blank according to said working instructions,
characterized in that neurological proceptors are placed on the scanner under the patient's foot in accordance with the patient's predisposition;
the proceptors being part of a set of standardized proceptors having various dimensions; and
the proceptors are identified by markings on their underside, whereby said scanned image contains the identifying markings and the orientation of the proceptors.

2-6. (canceled)

7. An arrangement for producing therapeutic insoles, comprising:
a platform for supporting at least one patient's foot;
a scanner for scanning an underside of said patient's foot in said platform and creating a scanned image;
at least one computer containing a data processing computer program;
at least one milling machine;
a data processing connection means for receiving and transmitting said image scanned by said scanner to said computer via at least one of a direct connection, a network connection, an internet connection, and a removable media connection;
said data processing computer program including means for receiving and converting said transmitted data into a set of working instructions for said milling machine;
said milling machine effective to mill said therapeutic insole from a blank according to said working instructions during a milling operation;
at least one neurological proceptor having a shape selected in accordance with a patient's predisposition;
said proceptor being at least one of a set of standardized proceptors having various dimensions;
said at least one of said set of neurological proceptors on said scanner, positioned between said scanner and said underside of said foot in accordance with said patient's predisposition;
said proceptors being identified by at least one marking on at least their underside surface; and
said scanned image containing at least said identifying marking and an orientation of said proceptors, whereby said working instructions reflect said marking and said orientation and enable said scanned image to be manipulated according to a patient's neurological therapy prior to said transmitting to said milling machine to produce said therapeutic insole from said blank.

8. An arrangement, according to claim 7, wherein:
said markings and said orientation constitute additional computer information;
said additional computer information being transmitted by said data processing connection means and received and converted by said data processing computer program into an additional set of working instructions for said milling machine.

9. An arrangement, according to claim 7, wherein:
said markings identify at least one of a size and a form of said proceptors.

10. An arrangement, according to claim 8, wherein:
said markings identify at least one of a size and a form of said proceptors.

11. An arrangement, according to claim 7, wherein:
said markings consist of at least one of imprints, colorations, stickers, and embossing, whereby said markings are easily identified and reflect proceptor meaning.

12. An arrangement, according to claim 8, wherein:
said markings consist of at least one of imprints, colorations, stickers, and embossing, whereby said markings are easily identified and reflect proceptor meaning.

13. An arrangement, according to claim 7, wherein:
said markings on said proceptors include data referring to at least one of a depth, a slope, a dimension, and a surface texture of at least one of said proceptor and said therapeutic insole, whereby said arrangement enables a processing of said insole into a near-net final form maximizing patient comfort at a minimum cost.

14. A method for producing therapeutic insoles, comprising the steps of:
preparing a platform with a scanner for supporting and scanning an underside of a patient's foot;
aligning a patient's foot position in accordance with a predetermined orientation;
selecting proceptors according to a therapeutic predisposition of said patient;
arranging and positioning said selected proceptors under said patients foot according to said patient predisposition;
scanning said underside of said patient's foot and capturing an image of at least said foot, said proceptors, markings on said proceptors, and an orientation of said proceptors;
transmitting said scanned image to a designated computer means;
converting and processing said scanned image into at least one set of working instructions for controlling a milling machine, whereby said computer means is programmed with computing steps representing at least said markings and said orientation of said proceptors; and
milling a therapeutic insole from a selected prefabricated insole blank in accordance to said working instructions; whereby said working instructions are substantially based on a processing of scanned markings and an orientation of said proceptors thereby enabling a milling out of both a contour of said therapeutic insole and a dimension of said proceptors.

15. A method, according to claim 14, wherein:
said steps of scanning and milling follow in automatic sequence.

16. A method, according to claim 14, wherein said step of transmitting further comprises the step of:
transmitting said scanned image to said computer means via at least one of a wired and a wireless connection.

17. A method according to claim 14, wherein:
said markings on said proceptors includes data referring to at least one of a depth, a slope, said dimension, and a surface texture of at least one of said proceptor and said therapeutic insole, whereby said method enables a processing of said insole into a near-net final form.
